(19) United States
(12) Patent Application Publication
(10) Pub. No.: US 2020/0019895 A1
(43) Pub. Date: Jan. 16, 2020

(54) Systems and Methods for Capturing and Promoting Innovation

(71) Applicant: Florida Polytechnic University Board of Trustees, Lakeland, FL (US)

(72) Inventor: Justin Heacock, Lakeland, FL (US)

(21) Appl. No.: 16/388,303

(22) Filed: Apr. 18, 2019

Related U.S. Application Data
(60) Provisional application No. 62/659,422, filed on Apr. 18, 2018.

(51) Int. Cl. G06Q 10/06; G06Q 10/10

(52) U.S. Cl. CPC G06Q 10/067; G06Q 10/101; G06Q 10/0637

(57) ABSTRACT

Embodiments comprise systems and methods for capturing ideas and innovation, advancing innovation, mentoring innovators, and promoting awareness and recognition of innovation in a community. Exemplary systems include a first device configured for receiving information pertaining to an idea or an innovation, and a second device configured for signaling at least one of a receipt and status of the idea or innovation to a community.

### CROSS-REFERENCE TO RELATED APPLICATION

This application claims priority to, and the benefit of, U.S. Provisional Patent Application Ser. No. 62/659,422, filed Apr. 18, 2018, the disclosure of which is hereby incorporated by reference in its entirety and commonly owned.

### FIELD OF INVENTION

The present disclosure relates to systems and methods for capturing ideas and innovation, advancing innovation, mentoring innovators, and promoting awareness and recognition of innovation in a community.

### BACKGROUND

Existing systems, programs, and methods for capturing new and innovative ideas, inventions, and other technological advances, advancing and promoting the development of innovations and innovators, and building awareness and recognition of innovations and innovators in a community suffer from several undesirable limitations.

For instance, many universities, communities, businesses, and philanthropic organizations fund, operate, and manage what are commonly referred to as incubator programs for start-up or early-stage entrepreneurs or businesses. These incubator programs often provide workspace and other support for entrepreneurs and their start-up or early stage companies, such as offering lectures or access to skilled service providers through programs associated with the incubator. In large communities such as a university campus or city, existing incubator programs only identify a small percentage of innovations or ideas in the community, or only serve a limited number of entrepreneurs and start-up companies (10-25, for example on a large university campus of 20,000 to 50,000 students) in the community.

These existing programs typically identify only a limited number of innovations or innovators because they lack a targeted system or method for capturing and advancing ideas in a community on a large scale. Instead, existing incubator programs only identify and select a limited number of innovations and entrepreneurs/companies to participate in the incubator program based on certain selection criteria. These criteria include, for example, the availability of suitable office or lab space in the incubator, whether the candidate entrepreneur/company has a particular technology focus, and the candidate's developmental progress and future potential to meet an incubator's specific success criteria.

Existing programs often only capture and facilitate the advancement of a limited number of innovations that have already progressed to a more developed stage, such as the completion of a patent disclosure, development of a prototype, or the procurement of financial support, thereby leaving thousands of potentially viable ideas and innovations without the support needed to move through the development continuum from idea to commercialization. The limitations on the number of start-ups supported by an incubator program is often a function of limited work or lab space, limited supporting funds, and a limited ability to identify or capture innovative ideas in the community.

Existing systems and methods also lack an ability to collect a wide range of ideas at a variety of stages and then advance or promote the progress of the ideas and their innovators systematically through the development and commercialization process. Existing systems and methods also lack an effective means for providing awareness to a community of the progress of innovation therein. These systems also lack a means or methods for providing status updates to a community or segments of the community and also to allow the community members to engage in the process of inputting, viewing, and commenting on the progress of individual innovations or collective community goals at dispersed physical and/or virtual locations in the community.

The limitations of existing systems also inherently limit the types of data that can be collected and analyzed, thereby making it nearly impossible to effectively optimize the services provided. For instance, limited incubator space limits the number of incubator tenants, which in turn limits the ability to assess the most effective and efficient way to promote, educate, and/or advance a subject start-up or entrepreneur.

The innovators who are left behind by these existing programs often watch their ideas fade away into obscurity due to a lack of funding or a lack of educational resources for aiding in the advancement of the idea to a commercially viable stage. Thus, there is a need in the art for more effectively and efficiently capturing, promoting, and advancing innovation in a community. The embodiments disclosed herein are aimed at fulfilling these and other needs in the art.

### BRIEF DESCRIPTION OF THE DRAWINGS

FIG. 1 is a depiction of an embodiment of the system of the present disclosure;

FIG. 2 is a depiction of a statistical output of the system of the present disclosure;

FIG. 3 is depiction of a syllabus provided by the system of the present disclosure;

FIG. 4 is a depiction of a syllabus builder employed in connection with the system of the present disclosure;

FIG. 5 is a depiction of a leaderboard provided and employed in connection with the system of the present disclosure.

### DETAILED DESCRIPTION OF EXAMPLE EMBODIMENTS

This disclosure describes exemplary embodiments, but not all possible embodiments of the systems and methods for capturing and promoting innovation in a community. Where a particular feature is disclosed in the context of a particular example, that feature can also be used, to the extent possible, in combination with and/or in the context of other examples. The systems and methods disclosed herein may be embodied in many different forms and should not be construed as limited to only the examples described.

As used herein ideas and/or innovations captured and/or promoted by embodiments of the present disclosure can be in a wide range of forms and stages of concreteness or development. The innovations and ideas can include, but are not limited to a system, method, design, process, and/or device, or any combination thereof. The idea or innovation may be provided at any stage of development, including initial concept, written invention disclosure for consideration for patentability, prototype, academic publication, business plan, sketches, drawings, beta type, initial product, and/or commercially available product.

Innovators may include any user of the systems and methods disclosed herein, including individuals, grouping(s) of individuals such as a team working together informally on a project or innovation, or formal innovation groupings such as individuals that form a community. Individuals can be members of multiple innovation groups or communities.

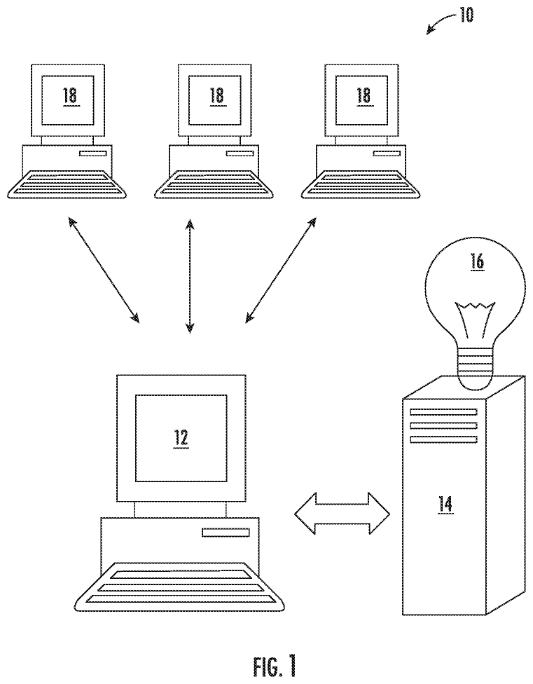

With reference initially to FIG. 1, an embodiment of the present disclosure comprises a system 10 for capturing and promoting innovation in a community, the system 10 comprising a first device 12 configured for receiving an idea or innovation and a second device 14 in communication with the first device 12 and comprising a signaling unit 16 configured for signaling a status of the idea to the community, thereby enhancing awareness and recognition of the idea or innovation in a community. A third device 18 configured for sending the idea to the first device is also envisioned as a component of an embodiment of the system.

The first device 12 may be any device capable of running software and/or hardware configured for receiving and/or collecting ideas submitted by a variety of potential users or members of a community, such as a computer, a smart phone, tablet, handheld device, or a kiosk. The idea or innovation may comprise, for example, an invention, a discovery, or any other idea conceived or provided by a user of the system or member of a community. The first device 12 may be further configured for assessing and assigning a developmental status of the idea, the details of which are described in greater detail hereinafter. The various devices of the present disclosure (i.e. the first device, second device, third device, fourth device, signaling unit, and so on) may communicate via any known wired or wireless means, such as Ethernet, Bluetooth®, Wi-Fi, cellular signal, radio signal, or otherwise.

With continued reference to FIG. 1, a second device 14 is provided including a signaling unit 16 which may comprise any suitable mechanism for signaling a status of an idea to a community. For example, the second device may comprise a kiosk, a pillar, a tower, television, digital or analog display unit, or other base unit, device, or structure operable with the signaling unit. In one embodiment, the second device may include a device for signaling the status of an innovation to a community, the device comprising a base unit configured for receiving a communication from a system, and a signaling unit configured for providing a signal to a community in response to the base unit's receipt of a communication from the system, wherein the communication relates to at least one of a submission of an idea to the system and a change in a status of an idea, and wherein the signal comprises at least one of a visual signal and an audible signal.

It will be appreciated by one of ordinary skill and having the benefit of the teachings of the present disclosure, that the functionality of the second device may be incorporated into the signaling unit, and vice versa, thereby reducing the number of devices needed to carry out the systems and methods of the present disclosure. The second device 14 may also comprise a user interface, such as a keypad, touchscreen, voice recognition unit, video camera, microphone, or other suitable interface for enabling a user to input an idea and/or innovation into the system.

The signaling unit may provide a visual signal in the form of a color-changing light, a variable intensity light, a display configured for presenting text and/or images to the community such as, for example, a television or a monitor, and the like. The signal may also comprise, for example, email, text, or SMS messaging between and among the various devices and/or components of the system. The signaling unit 16 may also provide an audible signal in the form of a sound, a siren, a chime, a tone, or any other suitable audible signal. The signaling unit 16 may further provide a vibration or other type of perceptible signal. By signaling the status of an innovation to the community, the system encourages other members or users to engage the system, thereby increasing the number of ideas collected from the community.

In one embodiment, the system comprises a single second device 14. In another embodiment, the system comprises multiple second devices. The second device(s) may be placed at a location proximate the first device or, alternatively, a location distant from the first device. In another embodiment, the system may comprise multiple second devices located at multiple sites within a community and/or multiple communities.

The community of the present disclosure may comprise any group of people, such as a university, a corporation, an organization, a city, and so on, or any combination or division thereof. The systems and methods disclosed herein may also be further modified to connect multiple communities to enable communication and collaboration therebetween. A community in one or more embodiments may comprise any group of members that recognize a common grouping, purpose, or identification as members of the community through various means, including grouping through shared physical or virtual space or environment such as a university campus, membership in a class such as students, faculty or staff of a university, online shared community or other affinity group whether by physical presence or common education, commercial grouping or affinity grouping such as members of a particular college in a university, company, professional association or other affinity grouping such as social media. The system(s) and method(s) disclosed can be utilized in a single community or track innovations across multiple separate or even overlapping communities for the functions of idea identification, advancement, education and mentoring, resource matching, and commercialization.

In one embodiment, the signaling unit 16 provides a signal in response to any number of predefined criteria. The signal may function to report the occurrence or non-occurrence of an event. For example, a signal may be provided in response to a receipt of an idea by the system. Other exemplary bases for providing a signal include, but are not limited to, a change in the developmental status of an idea, a change in the number of ideas received by the system, and an establishment of a collaboration or partnership between users of the system or members of a community, or other event, such as, for example, the achieving of a milestone, entry or acceptance into a competition, the receipt of an award, the filing of a patent application, a nomination for an award or prize, or any type of cause for celebration within the community. Alternatively, the signaling may be manually controlled by a user and/or administrator of the system, or member of the community, via any device of the system in a manner separate from any requirement of the fulfillment of a predetermined criteria. By providing a signal in response to an event, the system and methods of the present disclosure function to incentivize and promote interaction with the system, thereby increasing the level of capture and development of ideas within the community.

In one exemplary embodiment, the developmental status, or developmental stage, of the idea may be selected from the group consisting of a concept phase, a prototype phase, a pilot user phase, a paying user phase, and a fully-developed, or commercial, phase, such as, for example, a reproducible business model. In another context, the developmental status may comprise a series of predetermined stages appropriate for a given objective. Therefore, other desirable and/or appropriate developmental stages are considered to be within the scope of the present disclosure.

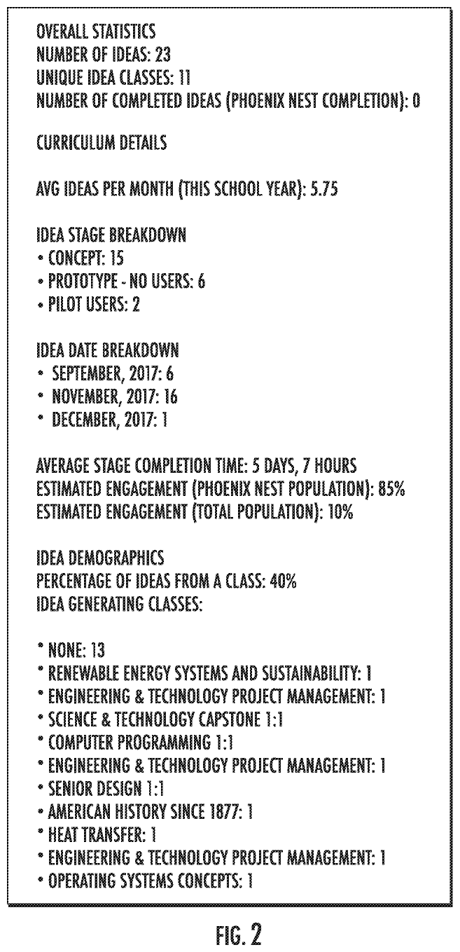

As depicted in FIGS. 1 and 2, a component of the system may be configured for computing, providing, and/or displaying statistics and/or metrics relating to the ideas received by the system. In one embodiment, the first device 12 provides and/or displays the statistics. In another embodiment, the second device 14 provides and/or displays the statistics. In yet another embodiment, a third 18 or fourth device (not shown) provides and/or displays the statistics. One of ordinary skill, having the benefit of the present disclosure, will understand that any number of devices may be used in connection with the systems and methods of the present disclosure without departing from the spirit and scope of the embodiments described.

With continued reference to FIG. 2, exemplary statistics/metrics provided and/or displayed by the system or a component thereof may include the number of ideas received by the system, unique idea classes or categories received by the system, the number of completed ideas (i.e. ideas advanced to a commercial or other desirable stage of development), the number of ideas per month (or other timeframe), an idea stage breakdown or summary, an idea receipt date breakdown or summary, an average developmental stage completion time, an estimated percent of the community engaged, a percentage of ideas received from a group and/or class, and a summary of idea-generating groups and/or classes. Other exemplary statistics may include a number of jobs created, where the ideas coming from, duration of time spent developing an idea, an activity status of an idea, how long a user takes to complete a stage of development, a rate of progression through a developmental stage, industry partnership projects initiated, completion of industry proposals, the amount of funding allocated to a user, and/or a number and location of jobs and/or companies created. This ability to collect and analyze data on a large scale in connection with embodiments of the present disclosure provides a unique ability to determine how best to advance and promote ideas and innovations in a community, which is a significant advantage over existing, limited systems.

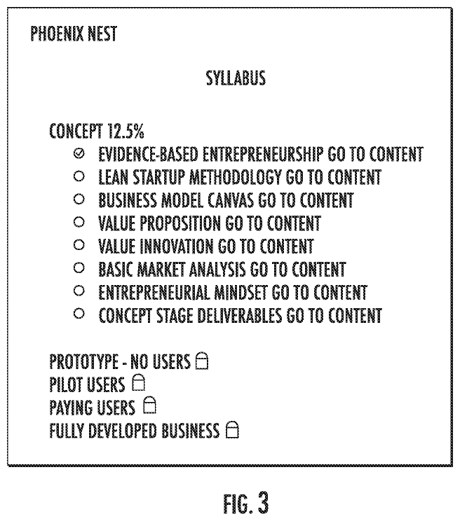

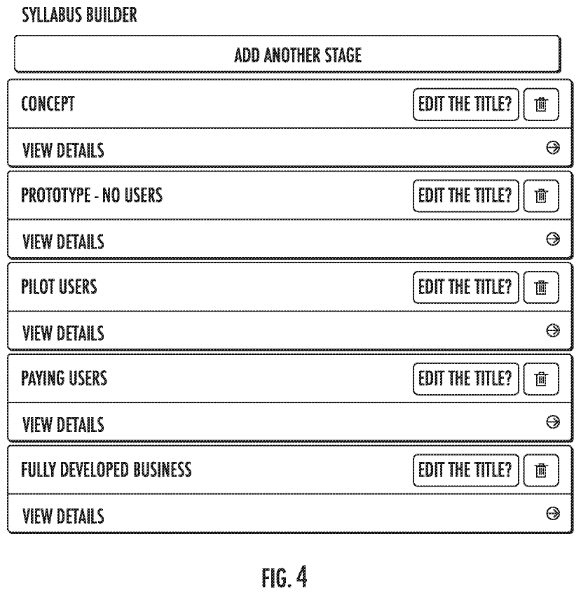

As depicted in FIG. 3, the system or a component thereof may be further configured for providing education options or offerings, such as a syllabus and related educational materials or modules, to a user based on the developmental status of the idea or other criteria. Accordingly, and as depicted in FIGS. 1 and 4, one embodiment of the system 10 includes a syllabus builder operable with at least one of the first 12, second 14, and third device(s) 18 for creating a syllabus. The syllabus and related education materials may be customized as needed for a particular community or type of user. For example, if the idea is in a concept stage, the system 10 may provide specific education options, offerings, materials, or modules for teaching a user how to advance their idea from the concept stage to a prototype stage.

In one embodiment, the concept stage includes coming up with a detailed concept. This can summed up by the user interaction, “I have a really cool idea but I don't know what to do next. Can you help me?” This stage will give the user a basic entrepreneurial framework to think through and analyze their ideas. Using Lean Startup Methodology each user will learn entrepreneurial concepts that they can duplicate in another startup or a future STEM related career.

Exemplary concept-stage education options may include, but are not limited to, information and/or key learning objectives pertaining to resource availability, faith-based vs. evidence-based entrepreneurship, lean startup methodology, business model canvas, value proposition, value innovation, basic market analysis, entrepreneurial mindset, growth mindset, and concept stage deliverables, such as, for example, a one page executive summary, a business model canvas, and a personal consultation with an administrator or other user or non-user of the system. Education options and/or offerings may be provided or displayed in a manner that enables a user to select the option they wish to explore or access. Alternatively, the options and/or offerings may be limited or restricted pending a user's completion of certain prerequisite education options or other criteria. Means for tracking a user's progress as they advance through the syllabus are also envisioned as a component of the system.

Likewise, once an idea advances from a concept stage to a prototype stage, the system 10 may then provide a user with access to education options for teaching a user how to advance their idea from the prototype stage to a pilot user stage, and so on. Thus, one objective of the systems and methods described herein is to enable a user to advance the developmental stage of an idea from concept to commercialization in a stepwise manner, said advancement being facilitated by the fulfilling of certain educational criteria at various stages of development.

In one embodiment, Prototype—No Current Users is the stage where the ideas start to get off the paper and become reality. There may be a small cash infusion when the user enters this stage after completing the basic research requirements of the Concept stage. The funds may be used to move the idea to a working prototype or Minimal Viable Product. During this stage the user will become familiar with the various resources in the community that can help develop functional prototypes needed to better test their idea.

Exemplary prototype-stage education options may include, but are not limited to, information and/or key learning objectives pertaining to Build-Measure-Learn Feedback Loop, Customer Archetypes, Innovation Accounting, Entrepreneurial Prototyping Mindset, Intellectual Property Basics (Patent, Copyright, Trademark, Trade Dress, Trade Secret), and/or Mentorship Opportunities. Prototype stage deliverables may include a prototype or minimal viable product, innovation accounting competency, and a personal consultation with an administrator or other user or non-user of the system.

In one embodiment, Pilot Users is the stage where a user takes the prototype through the rigors of introducing it to customers to get the eventual goal of having someone using the product. This may be the turning point where a startup realizes they are on the cusp of something big and that they have built something people actually want. This stage will prepare a user for how to make sense of then unknown factors and how to test the assumptions behind their idea with customers. This stage may unlock additional seed capital that may be used to refine their prototypes as they work with their customers.

Exemplary pilot-stage education options may include, but are not limited to, Customer Discovery, New Venture Financing Basics (Angel, VC, Crowdfunding, Bootstrapping), Business Professionalism Basics, Developing a Pitch Deck, Delivering the Perfect Pitch, and Network of Service Providers for Small Businesses. Pilot stage deliverables may include customer discovery interviews, assumption testing document, pitch deck, and a personal consultation with an administrator or other user or non-user of the system.

In one embodiment, Paying Users is the stage where pilot users have transferred to actual customers by agreeing to pay a user for its product or service. At this stage, the user should have all the research done, have significant customer feedback, made various iterations of their product, and now have people using it and are about to make their first sale. This stage will get them to think about next steps for their business around things like their objectives with this venture as well as the most effective way to manage it. This stage may offer the last of the seed capital. This money is directed towards setting up incorporation and business processes as they start to sell.

Exemplary paying user stage education options may include, but are not limited to, Basic Financial Literacy (COGS and break even points), Business Basics (accounting, sales techniques, legal documents, bank accounts), Basic Sales Tactics, Basic Marketing Tactics, Incorporation Basics, How to Invoice a Customer, and/or Manufacturing. Paying user stage deliverables may include a paying customer, incorporation (i.e. entity formation), website, and a personal consultation with an administrator or other user or non-user of the system.

In one embodiment, Fully Developed Product or Service is the final stage in system for the development of startups. At this point the user should have business operations figured out, revenue generating, and be moving towards scaling. At this stage, the system may provide and/or enable connections to business leaders and industry partners in the user's field.

Exemplary fully-developed product or service education options may include, but are not limited to, Management Styles, Corporate Culture, Hiring and HR Basics, Venture Financing Advanced, Scalability, and/or Network of Investors.

The system 10 may further provide an idea board for a user to organize their ideas and the developmental status thereof. The idea board may be operable with any one or combination of devices employed by the systems of the present disclosure. The system may be further configured to enable users to communicate with one another via email, text message, SMS, or other communication means.

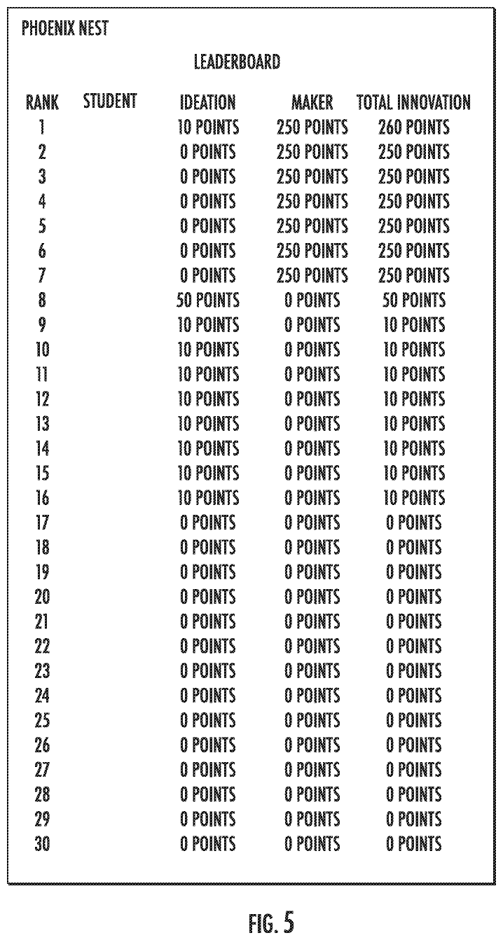

As depicted in FIGS. 1 and 5, the system 10 may further provide a leaderboard for displaying points or other metrics relating to a user's innovation progress. Points may be awarded in accordance with any suitable predefined criteria, such as, for example, the number of ideas submitted, the number of ideas advanced through a developmental stage, the amount of funding generated in connection with a particular idea or group of ideas, and so on. In one exemplary embodiment, a user may earn 10 points for submitting an idea to the system, 250 points for a first developmental stage advancement, and 500 points for a subsequent developmental stage advancement. The point system functions to further incentivize engagement with the system and the community, and serves to advance the entrepreneurial status of the community.

In addition to the systems described, another embodiment of the present disclosure comprises a method for promoting innovation in a community, the method comprising (i) receiving an idea from a user; (ii) determining a developmental status of the idea; and (iii) signaling the developmental status of the idea to the community. The developmental status of the idea may comprise at least one of a concept phase, a prototype phase, a pilot user phase, a paying user phase, and a fully developed phase. The signaling may comprise at least one of a visual signal, audible signal, or other perceptible signal. The signal may be based on a composite status of more than one idea, such as, for example, a number of ideas, the status of a single idea, or any other desirable analytic. The method may further comprise providing education to the user, the education selected in accordance with the developmental status of the idea.

Yet another embodiment of the present disclosure comprises a method for promoting progress of the useful arts, the method comprising (i) receiving an idea with a device, the device configured for providing a set of pre-established education modules categorized in accordance with a developmental stage of the idea; (ii) categorizing the idea based on the developmental stage; and (iii) providing at least one education module selected from the set of pre-established education modules based on the developmental stage of the idea. One embodiment of the method further comprises (iv) signaling a status of the idea to a community. The signaling may be performed via a signaling unit configured for providing at least one of a visual signal and an audible signal, such as, for example, a pillar of innovation.

### EXAMPLE

A user of the system inputs an idea in a device, such as the second device 14 or the third device 18. Software operable with the device initiates a transmission of the idea to the first device 12, where it is reviewed by a system administrator. The administrator assesses the developmental status of the idea and assigns the user the appropriate syllabus of educational offerings using software operable with the device employed by the administrator. As the user advances through and completes the educational offerings, the administrator promotes the developmental status of the idea within the system, thereby providing the user with additional educational offerings. The educational offerings may be accessed and completed by the user via the same device it used to input the idea, or via another device configured for communicating with the system. When the idea is received by the system 10, the signaling unit 16 of the second device 14 signals the receipt of the idea to the community. Further, when the developmental stage of the idea advances, another signal is sent to the community.

The systems and methods disclosed herein are not limited to the details described in connection with the example embodiments. One of ordinary skill in the art, having the benefit of the present disclosure, will appreciate that there are numerous variations and modifications of the systems and methods disclosed that may be made without departing from the scope of what is claimed.

What is claimed is:

1. A system for capturing and promoting innovation in a community, the system comprising:
a first device configured for receiving an idea; and
a second device in communication with the first device and comprising a signaling unit configured for signaling a status of the idea to the community.

2. The system of claim 1, wherein the idea comprises an invention.

3. The system of claim 1, wherein the signaling unit provides at least one of a visual signal and an audible signal.

4. The system of claim 3, wherein the visual signal is a light.

5. The system of claim 3, wherein the at least one of a visual signal and an audible signal varies in response to at least one predetermined criteria for assessing the status of the idea.

6. The system of claim 5, wherein the predetermined criteria comprise at least one of a number of ideas and a change in the status of the idea.

7. The system of claim 6, wherein the status comprises a developmental stage of the idea selected from the group consisting of concept phase, prototype phase, pilot user phase, paying user phase, and a fully developed phase.

8. The system of claim 1, wherein the first device is configured for providing statistics relating to the ideas.

9. The system of claim 8, wherein the statistics comprise at least one of a number of ideas, unique idea classes, number of completed ideas, number of ideas per month, idea stage breakdown, idea date breakdown, average stage completion time, estimated percent of the community engaged, percentage of ideas from a class, and idea generating classes.

10. The system of claim 1, wherein the first device is further configured for providing educational offerings based on the status of the idea.

11. A method for promoting innovation in a community, the method comprising:
receiving an idea from a user;
determining a developmental status of the idea; and
signaling the developmental status of the idea to the community.

12. The method of claim 11, wherein the developmental status of the idea comprises at least one of a concept phase, a prototype phase, a pilot user phase, a paying user phase, a fully developed phase, and a commercialization phase.

13. The method of claim 11, wherein the signaling comprises at least one of a visual signal and an audible signal.

14. The method of claim 11, wherein the signaling the developmental status of the idea comprises a signal based on a composite status of more than one idea.

15. The method of claim 14, wherein the composite status comprises a number of ideas.

16. The method of claim 11, further comprising providing education to the user, the education selected in accordance with the developmental status of the idea.

17. A method for promoting and advancing the progress of the useful arts, the method comprising:
receiving an idea with a device, the device configured for providing a set of pre-established education modules categorized in accordance with a developmental stage of the idea;
categorizing the idea based on the developmental stage; and
providing at least one education module selected from the set of pre-established education modules based on the developmental stage of the idea.

18. The method of claim 17, further comprising signaling a status of the idea to a community.

19. The method of claim 18, wherein the signaling is performed via a signaling unit configured for providing at least one of a visual signal and an audible signal.

20. The method of claim 19, wherein the signaling unit comprises a pillar of innovation.

21. A device for signaling the status of an innovation to a community, the device comprising:
a base unit configured for receiving a communication from a system; and
a signaling unit configured for providing a signal to a community in response to the base unit's receipt of a communication from the system, wherein the communication relates to at least one of a submission of an idea to the system and a change in a status of an idea, and wherein the signal comprises at least one of a visual signal and an audible signal.
